(19) United States
(12) Patent Application Publication
(10) Pub. No.: US 2002/0009120 A1
(43) Pub. Date: Jan. 24, 2002

(54) Burn-in system and burn-in method

(75) Inventors: Hiromitsu Sugimoto, Hyogo (JP); Shigehisa Yamamoto, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Tokyo (JP)

(21) Appl. No.: 09/756,192

(22) Filed: Jan. 9, 2001

(30) Foreign Application Priority Data
Jul. 19, 2000 (JP) P2000-218391

(51) Int. Cl. G01N 25/00

(52) U.S. Cl. 374/57; 73/865.6

(57) ABSTRACT

An object is to obtain a burn-in system which can speed up the burn-in not only in memory cell array portions but also in peripheral circuit and logic circuit portions. First, a wafer (3) to be evaluated is put in a constant temperature chamber (1a) and subjected to high temperature stress. The wafer (3) is then put in a constant temperature chamber (1b) and subjected to low temperature stress. The applications of the temperature stresses in the constant temperature chambers (1a) and (1b) may be repeatedly performed. When given temperature stresses have been applied to the wafer (3), the wafer (3) is conveyed to an evaluation unit (5). The evaluation unit (5) then checks whether failure exists in chips (30). If the evaluation determines that a chip (30) has a failure, whether to apply repair to the failure portion is decided and repair is applied if possible.

### BACKGROUND OF THE INVENTION

1. Field of the Invention

The present invention relates to the structure of a wafer-level burn-in system and a burn-in method for testing the reliability of semiconductor devices in the form of a wafer.

2. Description of the Background Art

Burn-in test of semiconductor devices is an accelerated aging test for screening out semiconductor devices having initial failures and semiconductor devices whose characteristics noticeably deviate from normal distributions, where the semiconductor devices are subjected to higher voltage stress or higher temperature stress than when they are actually used as products; after the application of the stress, the electrical characteristics of the semiconductor devices are evaluated.

In conventional applications, the burn-in test of semiconductor devices is performed after a wafer test; acceptable chips which passed the wafer test are assembled and packaged, and the semiconductor devices sealed in packages (packages of resin, ceramics, plastic, etc.) are subjected to the burn-in test. More specifically, a large number of packaged semiconductor devices are arranged on a burn-in board and are subjected to burn-in stress all together in a constant temperature chamber. The electric characteristics of each semiconductor device are then evaluated after the application of the stress.

FIG. 13 is a top view schematically showing the structure of a semiconductor storage device subject to the evaluation by the burn-in test. The chip 30 has a plurality of memory cell array portions 31, a peripheral circuit portion 32 and a logic circuit portion 33. Each memory cell array portion 31 has a plurality of memory cells arranged in a matrix, a plurality of word lines provided for individual rows of the memory cell array, and a plurality of bit lines provided for individual columns of the memory cell array. The peripheral circuit portion 32 has peripheral circuitry such as sense amplifiers etc. and a plurality of interconnections. The logic circuit portion 33 has random logic circuitry with a plurality of interconnections.

Methods for efficiently applying the burn-in test to such semiconductor storage devices include the method (Japanese Patent Application Laid-Open No. 5-144910 (1993)) where all bit lines and all word lines are selected all together and electric stress is applied to all memory cells at once and the method (Japanese Patent Application Laid-Open No. 4-756 (1992)) where all bit lines and half of the word lines are selected all together and electric stress is applied all at once to the memory cells connected to those word lines (half of all memory cells). In these methods, the rate of selection of the word lines in the memory cell array portions 31 is higher than that in actual use, so that the burn-in test can be achieved in a shorter time than a burn-in test where the word lines are selected one at a time as in the actual use. That is to say, the burn-in test can be speeded up.

However, some interconnections in the peripheral circuit portion 32 and the logic circuit portion 33 cannot be electrically selected all at once because of structural reasons. Therefore it has been difficult in the conventional burn-in test using application of electric stress to speed up the burn-in to the peripheral circuit portion 32 and the logic circuit portion 33.

### SUMMARY OF THE INVENTION

According to a first aspect of the present invention, a burn-in system comprises: a first stress applying portion for applying a first temperature stress to a wafer to be evaluated; a second stress applying portion for applying a second temperature stress to the wafer, the first temperature stress and the second temperature stress differing from each other; and an evaluating portion for evaluating whether a failure exists on the wafer after the application of the first and second temperature stresses.

Preferably, according to a second aspect, in the burn-in system, the first and second stress applying portions repeatedly apply the first and second temperature stresses to the wafer.

Preferably, according to a third aspect, in the burn-in system, each of the first and second stress applying portions is a constant temperature chamber whose inside is kept at a constant temperature.

Preferably, according to a fourth aspect, the burn-in system further comprises a wafer cassette for storing the wafer together with another wafer, and the first and second stress applying portions apply the first and second temperature stresses to the wafers being stored in the wafer cassette.

Preferably, according to a fifth aspect, the burn-in system further comprises a wafer cassette storage portion for storing the wafer cassette in the burn-in system, and the first and second stress applying portions are placed in the wafer cassette storage portion.

Preferably, according to a sixth aspect, in the burn-in system, each of the first and second stress applying portions is a constant temperature chamber whose inside is kept at a constant temperature, and the burn-in system further comprises a conveyor belt for conveying the wafer sequentially through the inside of the first and second stress applying portions.

Preferably, according to a seventh aspect, the burn-in system further comprises a wafer cassette storage portion for storing a wafer cassette to store the wafer together with another wafer in the burn-in system, and the conveyor belt and the first and second stress applying portions are placed in a convey route along which the wafers are conveyed between the wafer cassette storage portion and the evaluating portion.

Preferably, according to an eighth aspect, in the burn-in system, each of the first and second stress applying portions is a wafer stage on which the wafer can be placed and which is capable of setting of temperature.

Preferably, according to a ninth aspect, the burn-in system further comprises a wafer cassette storage portion for storing a wafer cassette to store the wafer together with another wafer in the burn-in system, and the first and second stress applying portions are placed in a transfer route along which the wafers are transferred between the wafer cassette storage portion and the evaluating portion.

Preferably, according to a tenth aspect, the burn-in system further comprises a closed housing in which the burn-in system is provided, wherein the inside space of the closed housing is kept in a vacuum state.

Preferably, according to an eleventh aspect, the burn-in system further comprises a closed housing in which the burn-in system is provided, wherein the inside space of the closed housing is filled with an inert gas.

Preferably, according to a twelfth aspect, in the burn-in system, each of the first and second stress applying portions is a constant temperature chamber whose inside is kept at a constant temperature, and the burn-in system further comprises a conveyor belt for conveying the wafer to the evaluating portion sequentially through the inside of the first and second stress applying portions, wherein the conveyor belt and the first and second stress applying portions are provided between the evaluating portion and a processing device for performing a process preceding the burn-in process.

According to a thirteenth aspect, a burn-in method comprises the steps of: (a) applying a first temperature stress to a wafer to be evaluated; (b) applying a second temperature stress to the wafer, the first temperature stress and the second temperature stress differing from each other; and (c) after the steps (a) and (b), evaluating whether a failure exists on the wafer.

Preferably, according to a fourteenth aspect, in the burn-in method, the steps (a) and (b) are repeatedly performed.

Preferably, according to a fifteenth aspect, the burn-in method further comprises the steps of (d) between the steps (a) (b) and the step (c), checking whether given burn-in stress has been applied to the wafer, and (e) repeating the steps (a) and (b) to the wafer when the step (d) has determined that the given burn-in stress has not been applied to the wafer.

Preferably, according to a sixteenth aspect, the burn-in method further comprises a step (d) of, after the step (c), applying repair to a part where a failure exists in the wafer.

According to the first aspect of the present invention, semiconductor devices having poor resistance to temperature stress can be screened out. Further, damage to the wafer can be avoided since it is not necessary to apply to the wafer such a probe needle as may be used in application of electric stress. Moreover, the burn-in stress can be uniformly applied to the entire area of the wafer.

Further, the burn-in test can be achieved in a shorter time because the temperature stress can be applied more efficiently than in a burn-in where temperature stress is applied to packaged chips. Also, repairs can be applied to repairable failures.

Moreover, the burn-in test does not require the process of raising/decreasing the temperature in the stress applying portions. Accordingly, as compared with a test where the first and second temperature stresses are applied by using one stress applying portion, the entire time for the burn-in test can be reduced and the lifetime of the stress applying portions can be lengthened.

According to the second aspect of the present invention, the first and second temperature stresses can be repeatedly applied to apply strong burn-in stress to the wafer.

According to the third aspect of the present invention, the burn-in test does not require the process of raising/decreasing the temperature in the constant temperature chambers. Accordingly, as compared with a test where the first and second temperature stresses are applied by varying the inside temperature in steps in one constant temperature chamber, the entire time for the burn-in test can be reduced and the lifetime of the constant temperature chambers can be lengthened.

According to the fourth aspect of the invention, a wafer cassette containing a plurality of wafers is put into the first and second stress applying portions. Therefore the temperature stresses can be uniformly applied to a plurality of wafers all at once so as to improve the efficiency of the process.

According to the fifth aspect of the invention, as a wafer cassette is taken out from the first and second stress applying portions, the next wafer cassette can be put in the first and second stress applying portions. Therefore, while a plurality of wafers stored in the preceding wafer cassette are being evaluated in the evaluating portion, the plurality of wafers stored in the next wafer cassette can be subjected to the first and second temperature stresses. Thus the temperature stresses can be applied by utilizing the standby time in the wafer cassette storage portion to improve the efficiency of the process.

According to the sixth aspect of the invention, a plurality of wafers can be placed on the conveyor belt to successively apply the first and second temperature stresses to the plurality of wafers.

According to the seventh aspect of the invention, while a wafer is being evaluated in the evaluating portion, the next wafer taken out from the wafer cassette can be subjected to the first and second temperature stresses by the first and second stress applying portions. Thus the temperature stresses can be applied by utilizing the standby time in the evaluating portion so as to improve the efficiency of the process.

According to the eighth aspect of the invention, the burn-in system can be smaller in size than a system using constant temperature chambers as the first and second stress applying portions.

According to the ninth aspect of the invention, while a wafer is being evaluated in the evaluating portion, the next wafer taken out from the wafer cassette can be subjected to the first and second temperature stresses by the first and second stress applying portions. Thus the temperature stress applications can be performed by utilizing the standby time in the evaluating portion so as to improve the efficiency of the process.

According to the tenth aspect of the invention, it is possible to prevent oxidation of the wafer by atmospheric oxygen when high temperature stress is applied to the wafer. It is also possible to prevent dew condensation on the wafer surface when the wafer is taken out into the normal temperature atmosphere after the application of low temperature stress.

According to the eleventh aspect of the invention, it is possible to prevent oxidation of the wafer by atmospheric oxygen when high temperature stress is applied to the wafer.

According to the twelfth aspect of the invention, while a wafer is being evaluated in the evaluating portion, the next wafer conveyed from the processing device by the conveyor belt can be subjected to the temperature stresses by the first and second stress applying portions. Thus the temperature stresses can be applied by utilizing the standby time in the evaluating portion to improve the efficiency of the process.

According to the thirteenth aspect of the present invention, semiconductor devices having poor resistance to temperature stress can be screened out. Further, damage to the wafer can be avoided since it is not necessary to apply to the wafer such a probe needle as may be used in application of electric stress. Moreover, the burn-in stress can be uniformly applied to the entire area of the wafer.

Further, the burn-in test can be achieved in a shorter time because the temperature stress can be applied more efficiently than in a burn-in where temperature stress is applied to packaged chips.

According to the fourteenth aspect of the present invention, the first and second temperature stresses can be repeatedly applied to apply strong burn-in stress to the wafer.

According to the fifteenth aspect of the invention, the steps (a) and (b) can be repeated to a wafer not exposed to sufficient burn-in stress, so that the burn-in stress can be uniformly applied to improve the reliability of the burn-in test.

According to the sixteenth aspect of the invention, wafers having failures can be repaired and then assembled, packaged and shipped as acceptable devices, which increases the number of chips obtained as acceptable devices per wafer.

The present invention has been made to solve the problems described above, and an object of the present invention is to obtain a burn-in system and a burn-in method which can speed up the burn-in not only in memory cell array portions but also in peripheral circuit and logic circuit portions.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view schematically showing the structure of a burn-in system according to a first preferred embodiment of the present invention.

FIG. 2 is a flowchart used to explain a burn-in method according to the first preferred embodiment of the invention.

FIG. 3 is a perspective view schematically showing the structure of a burn-in system according to a second preferred embodiment of the invention.

FIG. 4 is a perspective view schematically showing the structure of a burn-in system according to a third preferred embodiment of the invention.

FIG. 5 is a perspective view schematically showing the structure of a burn-in system according to a fourth preferred embodiment of the invention.

FIG. 6 is a perspective view schematically showing the structure of a burn-in system according to a fifth preferred embodiment of the invention.

FIG. 7 is a perspective view schematically showing the structure of another burn-in system according to the fifth preferred embodiment of the invention.

FIG. 8 is a perspective view schematically showing the structure of a burn-in system according to a sixth preferred embodiment of the invention.

FIG. 9 is a perspective view schematically showing the structure of a burn-in system according to a seventh preferred embodiment of the invention.

FIG. 10 is a perspective view schematically showing the structure of a burn-in system according to an eighth preferred embodiment of the invention.

FIG. 11 is a perspective view schematically showing the structure of a burn-in system according to a ninth preferred embodiment of the invention.

FIG. 12 is a perspective view schematically showing the structure of a burn-in system according to a tenth preferred embodiment of the invention.

FIG. 13 is a top view schematically showing the structure of a semiconductor storage device which is evaluated in a burn-in test.

### DESCRIPTION OF THE PREFERRED EMBODIMENTS

First Preferred Embodiment

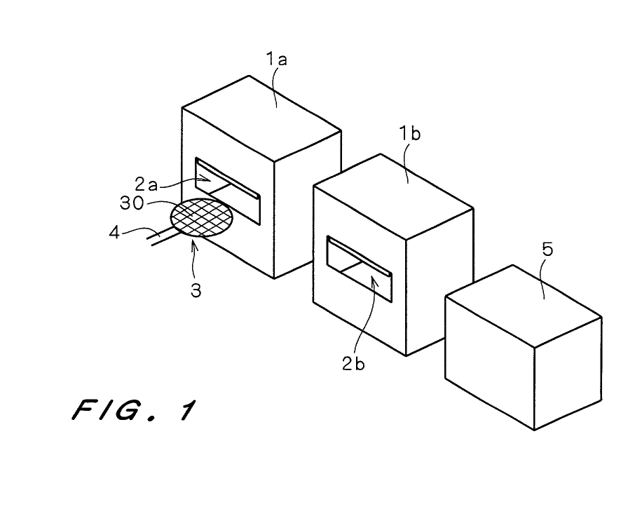

FIG. 1 is a perspective view schematically showing the structure of a burn-in system according to a first preferred embodiment of the present invention. The burn-in system has a constant temperature chamber 1a having a wafer entrance 2a, a constant temperature chamber 1b having a wafer entrance 2b, and an evaluation unit 5. The evaluation unit 5 is composed of known failure analyzing equipment for analyzing presence/absence of failures (and locations of the failures) on the chips 30 through electric testing. The inside of the constant temperature chamber 1a is kept at a high temperature of about 200 to 300° C. and the inside of the constant temperature chamber 1b is kept at a low temperature of about −80 to −40° C., for example. Note that these temperature conditions for the constant temperature chambers 1a and 1b are just examples and the temperatures are not limited to those. Although FIG. 1 shows only two constant temperature chambers 1a and 1b, three or more constant temperature chambers with different internal temperatures may be provided.

The wafer 3 has a plurality of chips 30 formed therein, each chip 30 having a plurality of memory cell array portions 31, a peripheral circuit portion 32, and a logic circuit portion 33 as shown in FIG. 13. Each memory cell array portion 31 has a plurality of memory cells arranged in a matrix, a plurality of word lines provided for individual rows of the memory cell array and a plurality of bit lines provided for individual columns of the memory cell array. The peripheral circuit portion 32 has peripheral circuitry such as sense amplifiers with a plurality of interconnections. The logic circuit portion 33 has random logic circuitry with a plurality of interconnections.

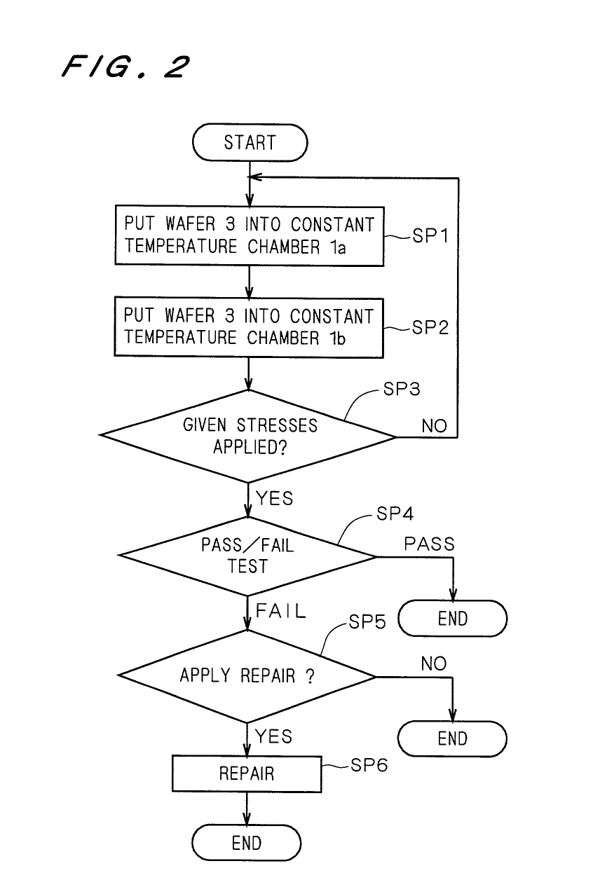

FIG. 2 is a flowchart used to explain a burn-in method according to the first preferred embodiment of the invention. Now the burn-in method of the first preferred embodiment is described referring to FIGS. 1 and 2. First, the wafer 3 to be evaluated is put into the constant temperature chamber 1a from the wafer entrance 2a by a transfer device 4 such as a wafer transfer arm etc. (step SP1). The wafer 3 is held in a constant temperature condition for several seconds to several minutes in the constant temperature chamber la; high temperature stress (about 200 to 300° C. in this example) is thus uniformly applied to the entire surface of the wafer 3.

Next, the wafer 3 is taken out from the constant temperature chamber 1a by the transfer device 4 and is put into the constant temperature chamber 1b from the wafer entrance 2b (step SP2). The wafer 3 is held in a constant temperature condition for several seconds to several minutes in the constant temperature chamber 1b; low temperature stress (about −80 to −40° C. in this example) is thus uniformly applied to the entire surface of the wafer 3.

Next, it is checked whether given temperature stresses have been applied to the wafer 3 (step SP3). For example, the testing steps are previously set in the burn-in system and whether given stresses have been applied is decided according to whether the number of stress applications or the length of the application time has reached a set value. When it is decided in step SP3 that the number of stress applications or the length of the application time has not reached the set value, then the flow returns to steps SP1 and SP2 to repeat the application of the temperature stresses in the constant temperature chambers 1a and 1b.

On the other hand, when step SP3 decides that the given stresses have been applied, the wafer 3 is taken out from the constant temperature chamber 1b by the transfer device 4 and is transferred into the evaluation unit 5. The evaluation unit 5 checks whether any failure has occurred in the chips 30 (PASS/FAIL test: step SP4). More specifically, current is externally applied to the circuitry fabricated in the chips 30 and the current value flowing in the circuitry is measured to see whether failure exists. When any failure exists, the location of the failure is searched for. Alternatively, address data is externally inputted to the circuitry and the output value is examined to see whether failure exists. When any failure is present, its location is searched for.

If the PASS/FAIL test in step SP4 decides that a certain chip 30 has a failure, it is further decided whether to apply repair to that failure (step SP5). The “repair” means replacing a circuit having a failure like disconnection etc. with an equivalent circuit prepared. If the failure exists in a part for which no spare circuit is prepared, or when the same part is defective in many chips and the spare circuits have been used up, for example, the failure is not repairable and a decision is made not to apply repair.

For the decision as to whether repair is possible or not, data indicating the relation between the failure positions and the numbers of spare circuits is previously taught to the burn-in system and the system automatically decides whether repair is possible about each failure position by referring to the data. Or the operator may decide whether repair is possible on the basis of information about the failure locations. When the decision in step SP5 is YES, repair is applied to that failure position (step SP6).

Chips 30 which have been PASSed in step SP4 and chips 30 repaired in step SP6 undergo processes of assembling, packaging, etc. and shipped as products. On the other hand, chips 30 determined as NO in step SP5 (i.e. chips having failures and not repairable) are disposed of as defective chips, without undergoing assembly process etc.

As explained above, the burn-in system and the burn-in method of the first preferred embodiment conduct the burn-in test by applying temperature stress as burn-in stress, whereas conventional ones use electric stress. Therefore, when strong stress is generated at the interface between interconnection and contact hole because of a difference in thermal expansion coefficient, it is possible to cause that part to appear as a failure in an accelerated manner. In other words, semiconductor devices having poor resistance to temperature stress can be screened out by the burn-in test.

Furthermore, while electric stress is applied by applying a probe needle onto pads formed on the chips, the burn-in stress can be applied without probing in this method since only the temperature stress is applied as the burn-in stress. Therefore it is possible to avoid probing-induced damage etc. to the chips.

In conventional applications using electric stress, the stress may be applied nonuniformly, with some circuits not exposed to sufficient electric stress. In contrast, in the burn-in system and the burn-in method of the first preferred embodiment, the temperature stress can be uniformly applied as burn-in stress onto the chips 30 on the wafer 3 or onto the individual regions 31 to 33 in each chip 30. Thus, as compared with a test using electric stress, the burn-in test of the invention can apply the stress more uniformly to reliably test a larger area at a time.

Furthermore, according to the burn-in system and the burn-in method of the first preferred embodiment, the semiconductor devices to be evaluated are put in the constant temperature chambers 1a and 1b and subjected to temperature stresses not in packaged form but in highly heat-conductive wafer form not assembled nor packaged yet. Hence, the temperature stress can be applied more efficiently and in a wider temperature range than in a test where the temperature stress is applied to packaged semiconductor devices, thus reducing the time required for the burn-in test.

Moreover, devices with repairable failures can be assembled and packaged after the repairs and can be shipped as acceptable devices. This increases the number of chips obtained as acceptable devices per wafer.

Furthermore, in the burn-in system and the burn-in method of the first preferred embodiment, the temperature stresses are applied to the semiconductor devices in the plurality of constant temperature chambers 1a and 1b kept at different internal temperatures. Accordingly, unlike a test where the internal temperature is varied in steps to apply temperature stresses in one constant temperature chamber, the burn-in test does not require time for raising/decreasing the chamber temperature, which reduces the entire time required for the burn-in test and lengthens the lifetime of the constant temperature chambers.

Second Preferred Embodiment

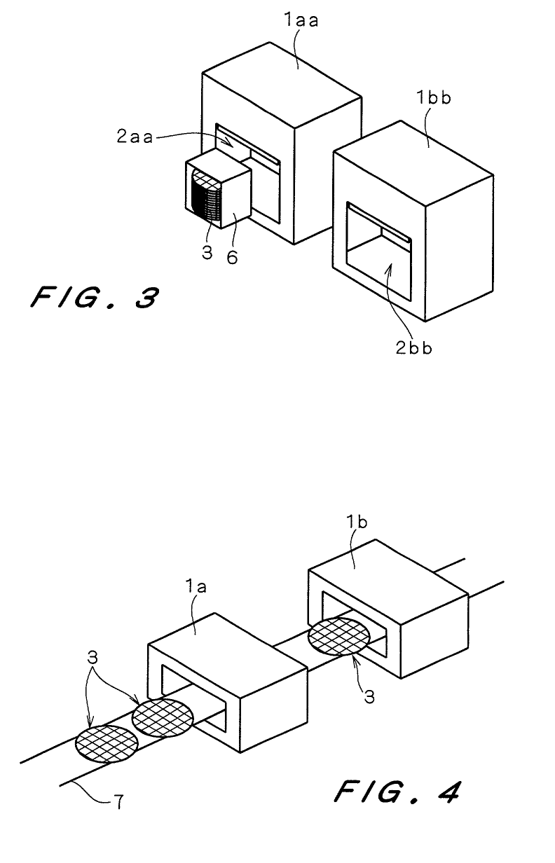

FIG. 3 is a perspective view schematically showing the structure of a burn-in system according to a second preferred embodiment of the present invention. Note that the evaluation unit 5 of FIG. 1 is not shown in this diagram for the sake of simplicity. While one wafer 3 is put at a time into the constant temperature chambers 1a and 11b in the first preferred embodiment, a plurality of wafers 3 are stored in a wafer cassette 6 and are put all together into the constant temperature chambers 1aa and 1bb in the second preferred embodiment. The constant temperature chambers 1aa and 1bb respectively have wafer cassette entrances 2aa and 2bb for entry of the wafer cassette 6. In other respects the burn-in system of the second preferred embodiment is the same in structure and operation as the burn-in system of the first preferred embodiment.

In the second preferred embodiment, as in the first preferred embodiment, the temperature stress application in the constant temperature chamber 1aa and the temperature stress application in the constant temperature chamber 1bb can be repeatedly conducted.

As described above, according to the burn-in system and the burn-in method of the second preferred embodiment, the wafer cassette 6 containing a plurality of wafers 3 is put in the constant temperature chambers 1aa and 1bb so that the temperature stresses can be uniformly applied to the plurality of wafers 3 all at once, thus improving the efficiency of the process.

Third Preferred Embodiment

FIG. 4 is a perspective view schematically showing the structure of a burn-in system according to a third preferred embodiment of the invention. Note that the evaluation unit 5 of FIG. 1 is not shown in this diagram for the sake of simplicity. A plurality of wafers 3 are successively placed on and conveyed by a conveyor belt 7. The constant temperature chambers 1a and 1b are located in the route along which the conveyor belt 7 conveys the wafers 3; the conveyor belt 7 passes through the inside of the constant temperature chambers 1a and 11b.

In order to apply given temperature stress to the wafers 3, the conveyor belt 7 is temporarily stopped when the wafers 3 come in the constant temperature chambers 11a and 1b. Alternatively, instead of being temporality stopped, the conveyor belt 7 can be continuously driven at low speed so that the wafers 3 pass through the constant temperature chambers 1a and 1b slowly enough. This method is certainly possible since the wafers have high thermal conductivity. In other respects, the burn-in system of the third preferred embodiment is the same in structure and operation as the burn-in system of the first preferred embodiment.

The conveyor belt 7 can be driven in normal and reverse directions so that a single wafer 3 can repeatedly undergo the temperature stress in the constant temperature chamber 1a and the temperature stress in the constant temperature chamber 1b. In this case, it is desired that the wafers 3 on the conveyor belt 7 be spaced apart from each other at intervals larger than the interval between the constant temperature chamber 1a and the constant temperature chamber 1b. Alternatively, the temperature stress application in the constant temperature chamber 1a and the temperature stress application in the constant temperature chamber 1b can be repeated by providing a plurality of pairs of the constant temperature chambers 1a and 1b in the route along which the conveyor belt 7 conveys the wafers 3. This applies also to the tenth preferred embodiment described later.

As described above, according to the burn-in system and the burn-in method of the third preferred embodiment, the wafers 3 are placed on the conveyor belt 7 and are sequentially passed through the constant temperature chambers 1a and 1b. When a plurality of wafers 3 are thus carried on the conveyor belt 7, the plurality of wafers 3 can successively undergo the given temperature stresses.

Fourth Preferred Embodiment

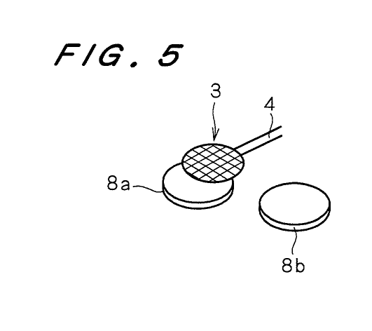

FIG. 5 is a perspective view schematically showing the structure of a burn-in system according to a fourth preferred embodiment of the present invention. Note that the evaluation unit 5 of FIG. 1 is not shown in this diagram. In the first preferred embodiment, the wafer 3 is put into the constant temperature chambers 1a and 1b and exposed to given temperature stresses. In contrast, the burn-in system and the burn-in method of the fourth preferred embodiment use a plurality of wafer stages 8a and 8b each containing a heater, cooler, etc. and capable of setting of the temperature; the wafer 3 is sequentially placed on the wafer stages 8a and 8b by the transfer device 4. Instead of transferring the wafer 3 with the transfer device 4, the wafer stages 8a and 8b may be moved with the wafer 3 fixed. Given temperature stress can be applied to the wafer 3 through the surface contact with the wafer stages 8a and 8b, since wafers have high thermal conductivity. In other respects the burn-in system of the fourth preferred embodiment is constructed and operate in the same way as the burn-in system of the first preferred embodiment.

In the fourth preferred embodiment, as in the first preferred embodiment, it is possible to repeatedly perform the temperature stress application with the wafer stage 8a and the temperature stress application with the wafer stage 8b.

As described above, according to the burn-in system and the burn-in method of the fourth preferred embodiment, given temperature stresses can be applied to the wafer 3 by placing the wafer 3 on the wafer stages 8a and 8b, instead of putting it in the constant temperature chambers 1a and 1b, thus providing the same effects as those of the first preferred embodiment.

Furthermore, the burn-in system can be smaller in size than the system using the constant temperature chambers 1 a and 1b shown in the first preferred embodiment.

Fifth Preferred Embodiment

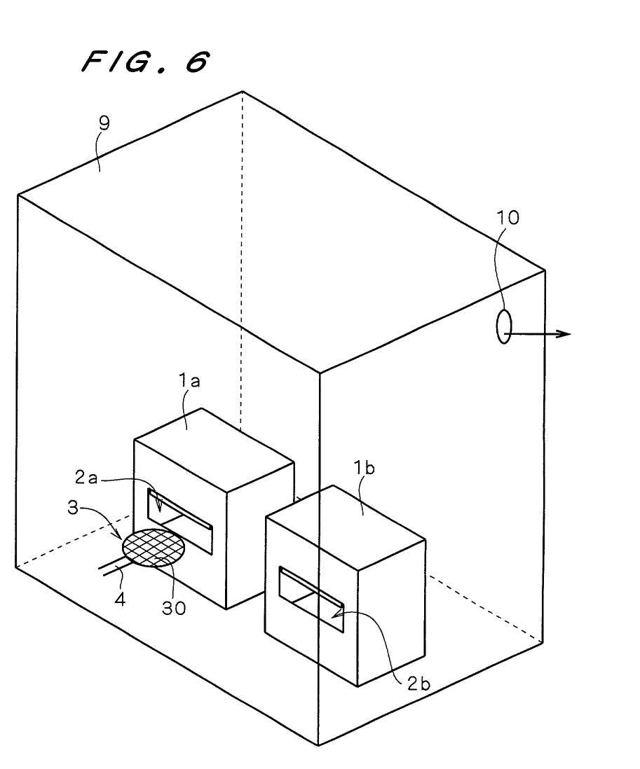

FIG. 6 is a perspective view schematically showing the structure of a burn-in system according to a fifth preferred embodiment of the present invention. Note that the evaluation unit 5 of FIG. 1 is not shown in this diagram. In the burn-in system of the sixth preferred embodiment shown in FIG. 6, the entirety of the burn-in system of FIG. 1 shown in the first preferred embodiment is provided within a closed housing 9. The closed housing 9 has an air evacuating hole 10 formed on it side wall. The air in the closed housing 9 is evacuated through the air evacuating hole 10 to keep the inside of the closed housing 9 in a vacuum state.

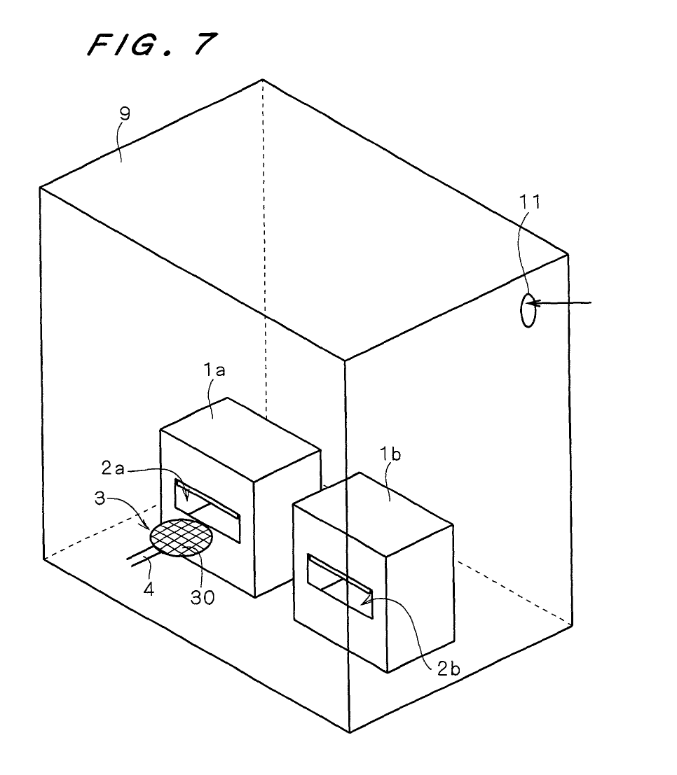

FIG. 7 is a perspective view schematically showing the structure of another burn-in system of the fifth preferred embodiment of the invention. Note that the evaluation unit 5 of FIG. 1 is not shown in this diagram. In the burn-in system of the sixth preferred embodiment shown in FIG. 7, the entirety of the burn-in system of FIG. 1 shown in the first preferred embodiment is provided within a closed housing 9 having a gas introducing hole 11 formed on its side wall. The closed housing 9 is filled with inert gas such as nitrogen introduced through the gas introducing hole 11.

In other respects the burn-in systems of the fifth preferred embodiment are the same in structure and operation as the burn-in system of the first preferred embodiment. Although the description above has shown examples where the invention of the fifth preferred embodiment is applied to the burn-in system of FIG. 1 shown in the first preferred embodiment, the invention of the fifth preferred embodiment can be applied also to the burn-in systems of FIGS. 3 to 5 shown in the second to fourth preferred embodiments.

According to the burn-in system of the fifth preferred embodiment shown in FIG. 6, the burn-in system is enclosed in the closed housing 9 and the inside of the closed housing 9 is kept vacuum. This prevents oxidation of the wafer 3 by oxygen in the atmosphere during the application of the high temperature stress to the wafer 3, and it also prevents dew condensation on the surface of the wafer 3 when the wafer 3 is taken out into the normal temperature atmosphere after the application of the low temperature stress.

According to the burn-in system of the fifth preferred embodiment shown in FIG. 7, the burn-in system is enclosed in the closed housing 9 and the closed housing 9 is filled with inert gas. This prevents oxidation of the wafer 3 by oxygen in the atmosphere during the application of the high temperature stress to the wafer 3. In order to prevent dew condensation on the surface of the wafer 3 when the wafer 3 is taken out into the normal temperature atmosphere after the application of the low temperature stress, it is desirable to fill the closed housing 9 with dried inert gas.

Sixth Preferred Embodiment

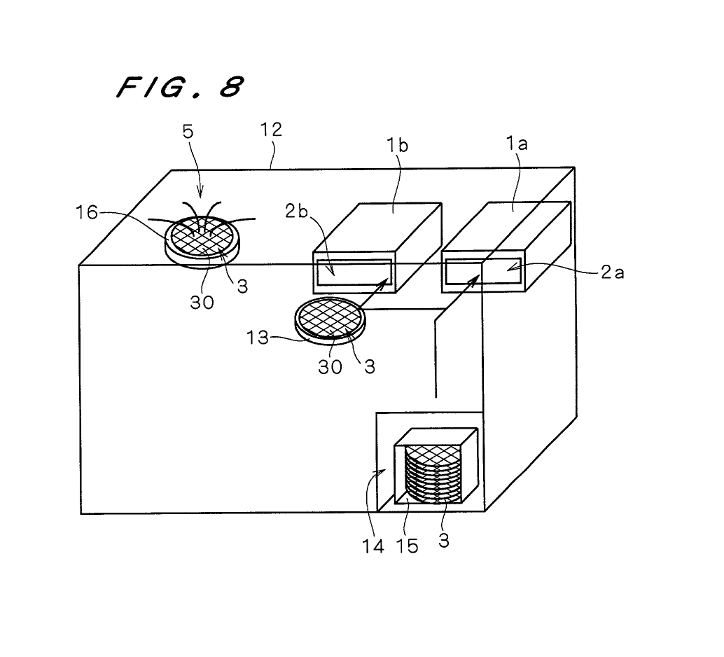

FIG. 8 is a perspective view schematically showing the structure of a burn-in system 12 according to a sixth preferred embodiment of the present invention. The burn-in system 12 has a wafer cassette entrance 14; a plurality of wafers 3 to be evaluated are stored in a wafer cassette 15 and are put in the burn-in system 12 from the outside through the wafer cassette entrance 14.

The wafers 3 put in the burn-in system 12 are taken out from the wafer cassette 15 and transferred one by one to the evaluation unit 5 by a wafer transfer apparatus 13. Although FIG. 8 shows only one wafer transfer apparatus 13, a plurality of wafer transfer apparatuses are prepared in practice. In the burn-in system 12 of the sixth preferred embodiment, the constant temperature chambers 1a and 1b of the first preferred embodiment are provided in the transfer route from the place where the wafer cassette 15 is stored in the burn-in system 12 to the evaluation unit 5. First, the wafers 3 taken out from the wafer cassette 15 are transferred sequentially to the constant temperature chambers 1a and 1b and are subjected to given temperature stresses according to the burn-in method of the first preferred embodiment. They are next transferred to the evaluation unit 5 and placed on its wafer evaluation stage 16 where the characteristics of the wafer 3 are evaluated. The plurality of wafers 3 are taken out from the wafer cassette 15 and are transferred one after another by a plurality of wafer transfer apparatuses 13 according to the above-described transfer order.

As described above, according to the burn-in system and the burn-in method of the sixth preferred embodiment, the constant temperature chambers 1a and 1b of the first preferred embodiment are provided in the transfer route from the place where the wafer cassette 15 is stored in the system to the evaluation unit 5, and the plurality of wafers 3 taken out from the wafer cassette 15 are transferred one after another by the plurality of wafer transfer apparatuses 13. Therefore, while one wafer 3 is being evaluated in the evaluation unit 5, the next wafer 3 can undergo given temperature stresses in the constant temperature chambers 1a and 1b. The temperature stresses can thus be applied by utilizing the standby time in the evaluation unit 5, so as to improve the efficiency of the process.

When the housing of the burn-in system 12 is constructed as a closed housing, the internal space of the housing can be maintained vacuum or filled with inert gas to obtain the effects of the burn-in systems of the fifth preferred embodiment. This applies also to the seventh to ninth preferred embodiments described below.

Seventh Preferred Embodiment

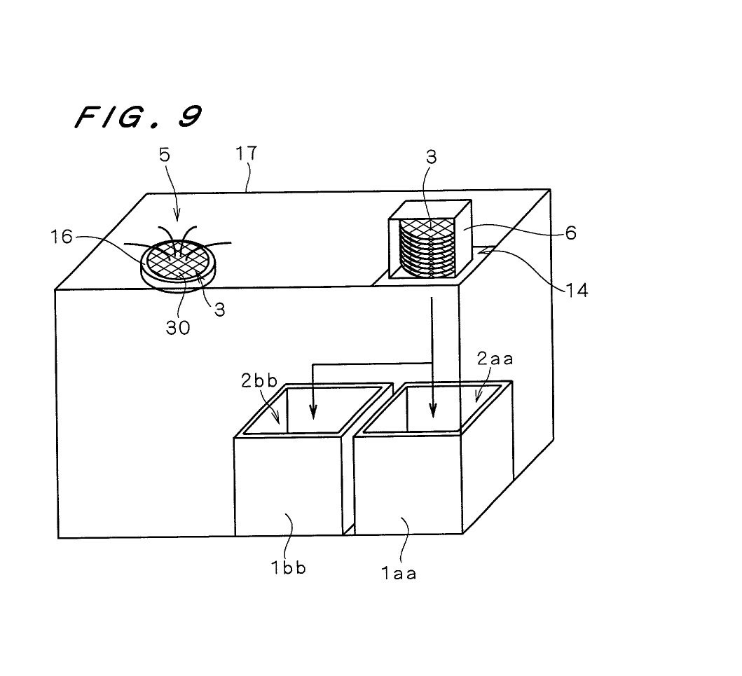

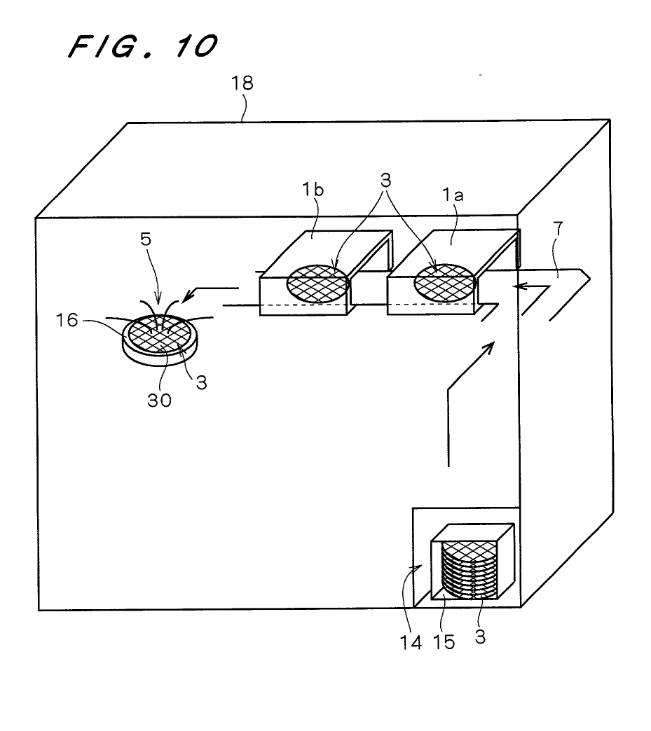

FIG. 9 is a perspective view schematically showing the structure of a burn-in system 17 according to a seventh preferred embodiment of the present invention. The burn-in system 17 has a wafer cassette entrance 14. The plurality of wafers 3 to be evaluated are stored in the wafer cassette 6 and are put into the burn-in system 17 through the wafer cassette entrance 14 from the outside. Although FIG. 9 shows only one wafer cassette 6, a plurality of wafer cassettes are prepared in practice.

In this burn-in system 17 of the seventh preferred embodiment, the constant temperature chambers 1aa and 1bb of the second preferred embodiment are positioned in the place where the wafer cassettes 6 are stored in the system (a wafer cassette storage portion). The wafer cassette 6 put in the system through the wafer cassette entrance 14 is sequentially transferred to the constant temperature chambers 1aa and 1bb according to the burn-in method of the second preferred embodiment. The given temperature stresses are applied to the wafers 3 in the constant temperature chambers 1aa and 1bb and then the wafer cassette 6 is taken out from the constant temperature chambers 1aa and 1bb. Then the wafers 3 are taken out from the wafer cassette 6 and transferred to the evaluation unit 5 by the wafer transfer apparatuses 13 (not shown in FIG. 9) where the characteristics of the wafers 3 are evaluated. As a wafer cassette 6 is taken out from the constant temperature chambers 1aa and 1bb, the next wafer cassette 6 is put into the burn-in system 17 and sequentially transferred to the constant temperature chambers 1aa and 1bb as explained above.

As described above, according to the burn-in system and the burn-in method of the seventh preferred embodiment, the constant temperature chambers 1aa and 1bb of the second preferred embodiment are provided in the place where the wafer cassettes 6 are stored in the burn-in system 17. When one wafer cassette 6 is taken out from the constant temperature chambers 1aa and 1bb, the next wafer cassette 6 is transferred to the constant temperature chambers 1aa and 1bb. Accordingly, while the evaluation unit 5 is evaluating a plurality of wafers 3 stored in the preceding wafer cassette 6, the constant temperature chambers 1aa and 1bb can apply the given temperature stresses to a plurality of wafers 3 contained in the next wafer cassette 6. Thus the temperature stress can be applied by utilizing the standby time in the place where the wafer cassettes are stored in the system, so as to improve the efficiency of the process.

Eighth Preferred Embodiment

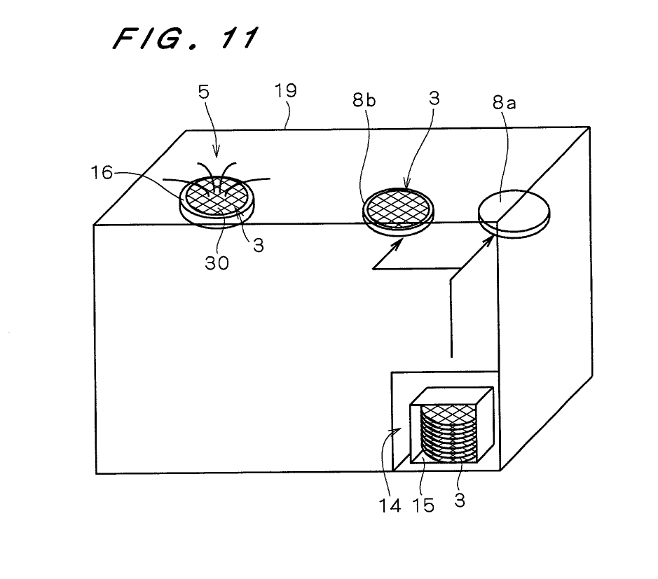

FIG. 10 is a perspective view schematically showing the structure of a burn-in system 18 according to an eighth preferred embodiment of the present invention. The burn-in system 18 has a wafer cassette entrance 14. A plurality of wafers 3 to be evaluated are stored in the wafer cassette 15 and are put into the burn-in system 18 from the outside through the wafer cassette entrance 14.

The wafers 3 put in the burn-in system 18 are taken out from the wafer cassette 15 and are transferred one by one to the evaluation unit 5 by the conveyor belt 7 shown in FIG. 4 in the third preferred embodiment. In the burn-in system 18 of the eighth preferred embodiment, the constant temperature chambers 1a and 1b of the third preferred embodiment are placed in the transfer route along which the conveyor belt 7 conveys the wafers 3 from the place where the wafer cassette 15 is stored in the burn-in system 18 to the evaluation unit 5. The wafers 3 taken out from the wafer cassette 15 are first conveyed sequentially to the constant temperature chambers 1a and 1b by the conveyor belt 7 and are subjected to the given temperature stresses according to the burn-in method of the third preferred embodiment. The wafers 3 are then conveyed to the evaluation unit 5 and are placed on the wafer evaluation stage 16 of the evaluation unit 5 where the characteristics of each wafer 3 are evaluated. The plurality of wafers 3 taken out from the wafer cassette 15 are conveyed one after another by the conveyor belt 7 according to the above-described conveying order.

As described above, according to the burn-in system and the burn-in method of the eighth preferred embodiment, the conveyor belt 7 of the third preferred embodiment and the constant temperature chambers 1a and 1b are placed in the convey route from the place where the wafer cassette 15 is stored in the system to the evaluation unit 5, and the plurality of wafers 3 taken out from the wafer cassette 15 are conveyed by the conveyor belt 7 one after another. Accordingly, while the evaluation unit 5 is evaluating a certain wafer 3, the next wafer 3 can undergo the given temperature stresses in the constant temperature chambers 1a and 1b. The temperature stress can thus be applied by utilizing the standby time in the evaluation unit 5 to improve the efficiency of the process.

Ninth Preferred Embodiment

FIG. 11 is a perspective view schematically showing the structure of a burn-in system 19 of a ninth preferred embodiment of the present invention. The burn-in system 19 has a wafer cassette entrance 14, and a plurality of wafers 3 to be evaluated are stored in the wafer cassette 15 and put into the burn-in system 19 from the outside through the wafer cassette entrance 14.

The wafers 3 put in the burn-in system 19 are taken out from the wafer cassette 15 and conveyed one by one by the wafer transfer apparatuses 13 (not shown in FIG. 11) to the evaluation unit 5. In the burn-in system 19 of the ninth preferred embodiment, the wafer stages 8a and 8b of the fourth preferred embodiment are placed in the transfer route from the place where the wafer cassette 15 is stored in the burn-in system 19 to the evaluation unit 5. The wafers 3 taken out from the wafer cassette 15 are first transferred sequentially to the wafer stages 8a and 8b, where the given temperature stresses are applied according to the burn-in method of the fourth preferred embodiment. They are then transferred to the evaluation unit 5 and placed on the wafer evaluation stage 16 of the evaluation unit 5, where the characteristics of the wafers 3 are evaluated. The plurality of wafers 3 taken out from the wafer cassette 15 are transferred by the plurality of wafer transfer apparatuses 13 one after another according to the above-described transfer order.

As described above, according to the burn-in system and the burn-in method of the ninth preferred embodiment, the wafer stages 8a and 8b of the fourth preferred embodiment are placed in the transfer route from the place where the wafer cassette 15 is stored in the system to the evaluation unit 5 and the plurality of wafers 3 taken out from the wafer cassette 15 are transferred one after another by the plurality of wafer transfer apparatuses 13. Therefore, while the evaluation unit 5 is evaluating a wafer 3, the given temperature stresses can be applied to the next wafer 3 on the wafer stages 8a and 8b. Thus the temperature stress can be applied while utilizing the standby time in the evaluation unit 5 to improve the efficiency of the process.

Tenth Preferred Embodiment

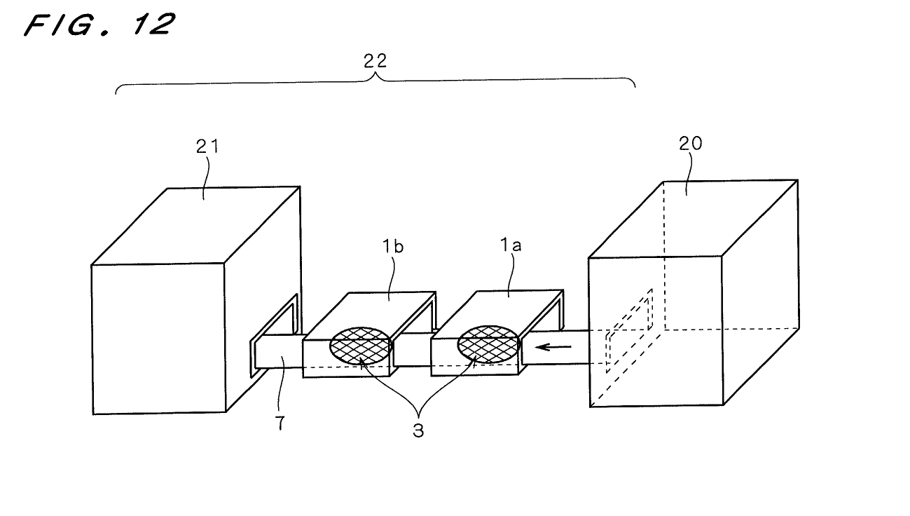

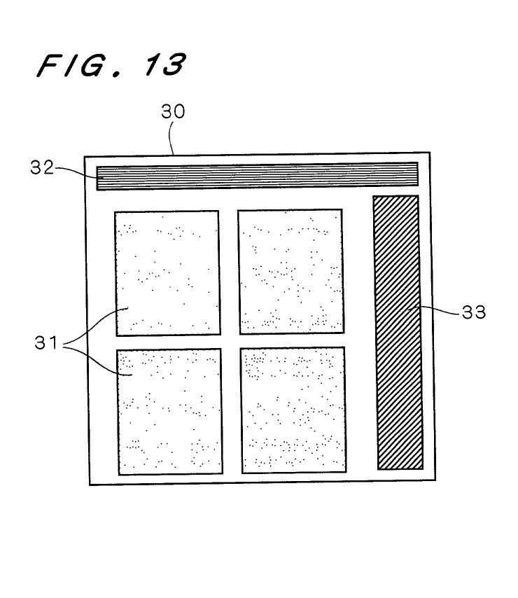

FIG. 12 is a perspective view schematically showing the structure of a burn-in system 22 according to a tenth preferred embodiment of the invention. The burn-in system 22 has an evaluation device 21 corresponding to the evaluation unit 5, a conveyor belt 7 connecting the evaluation device 21 and a testing device 20 provided in the previous stage, and the constant temperature chambers 1a and 1b placed in the route along which the conveyor belt 7 conveys the wafers 3. The testing device 20 is, for example, a device for performing a wafer test prior to the burn-in test.

Wafers 3 which passed the wafer test are successively placed on the conveyor belt 7. They are then exposed to given temperature stresses in the constant temperature chambers 1a and 1b according to the burn-in method of the third preferred embodiment and are further conveyed into the evaluation device 21. The evaluation device 21 then evaluates the characteristics of the wafers 3. While the description above has shown an example where the testing device 20 for conducting a wafer test is provided in the stage preceding the burn-in system 22, any device can be provided there as long as it is a processing device for applying some process to the wafers 3 prior to the burn-in process.

As described above, according to the burn-in system and the burn-in method of the tenth preferred embodiment, the conveyor belt 7 of the third preferred embodiment and the constant temperature chambers 1a and 1b are placed in the route along which the wafers 3 are conveyed between the evaluation device 21 and the testing device 20 in the previous stage, and a plurality of wafers 3 conveyed out from the testing device 20 are conveyed by the conveyor belt 7 one after another. Accordingly, while a wafer 3 is being evaluated in the evaluation device 21, the next wafer 3 can be exposed to the given temperature stresses in the constant temperature chambers 1a and 1b. The temperature stresses can thus be applied by utilizing the standby time in the evaluation device 21 to improve the efficiency of the process.

While the invention has been described in detail, the foregoing description is in all aspects illustrative and not restrictive. It is understood that numerous other modifications and variations can be devised without departing from the scope of the invention.

What is claimed is:

1. A burn-in system comprising:
a first stress applying portion for applying a first temperature stress to a wafer to be evaluated;
a second stress applying portion for applying a second temperature stress to said wafer, said first temperature stress and said second temperature stress differing from each other; and
an evaluating portion for evaluating whether a failure exists on said wafer after the application of said first and second temperature stresses.

2. The burn-in system according to claim 1, wherein said first and second stress applying portions repeatedly apply said first and second temperature stresses to said wafer.

3. The burn-in system according to claim 1, wherein each of said first and second stress applying portions is a constant temperature chamber whose inside is kept at a constant temperature.

4. The burn-in system according to claim 3, further comprising a wafer cassette storage portion for storing a wafer cassette to store said wafer together with another wafer in said burn-in system,
wherein said first and second stress applying portions are placed in a transfer route along which said wafers are transferred between said wafer cassette storage portion and said evaluating portion.

5. The burn-in system according to claim 1, further comprising a wafer cassette for storing said wafer together with another wafer, said first and second stress applying portions applying said first and second temperature stresses to said wafers being stored in said wafer cassette.

6. The burn-in system according to claim 5, further comprising a wafer cassette storage portion for storing said wafer cassette in said burn-in system,
wherein said first and second stress applying portions are placed in said wafer cassette storage portion.

7. The burn-in system according to claim 1, wherein each of said first and second stress applying portions is a constant temperature chamber whose inside is kept at a constant temperature, and
said burn-in system further comprises a conveyor belt for conveying said wafer sequentially through the inside of said first and second stress applying portions.

8. The burn-in system according to claim 7, further comprising a wafer cassette storage portion for storing a wafer cassette to store said wafer together with another wafer in said burn-in system,
wherein said conveyor belt and said first and second stress applying portions are placed in a convey route along which said wafers are conveyed between said wafer cassette storage portion and said evaluating portion.

9. The burn-in system according to claim 1, wherein each of said first and second stress applying portions is a wafer stage on which said wafer can be placed and which is capable of setting of temperature.

10. The burn-in system according to claim 9, further comprising a wafer cassette storage portion for storing a wafer cassette to store said wafer together with another wafer in said burn-in system,
wherein said first and second stress applying portions are placed in a transfer route along which said wafers are transferred between said wafer cassette storage portion and said evaluating portion.

11. The burn-in system according to claim 1, further comprising a closed housing in which said burn-in system is provided,
wherein the inside space of said closed housing is kept in a vacuum state.

12. The burn-in system according to claim 1, further comprising a closed housing in which said burn-in system is provided,
wherein the inside space of said closed housing is filled with an inert gas.

13. The burn-in system according to claim 1,
wherein each of said first and second stress applying portions is a constant temperature chamber whose inside is kept at a constant temperature, and
said burn-in system further comprises a conveyor belt for conveying said wafer to said evaluating portion sequentially through the inside of said first and second stress applying portions,
and wherein said conveyor belt and said first and second stress applying portions are provided between said evaluating portion and a processing device for performing a process preceding the burn-in process.

14. A burn-in method comprising the steps of:
(a) applying a first temperature stress to a wafer to be evaluated;
(b) applying a second temperature stress to said wafer, said first temperature stress and said second temperature stress differing from each other; and
(c) after said steps (a) and (b), evaluating whether a failure exists on said wafer.

15. The burn-in method according to claim 14, wherein said steps (a) and (b) are repeatedly performed.

16. The burn-in method according to claim 14, further comprising the steps of,
(d) between said steps (a) (b) and said step (c), checking whether given burn-in stress has been applied to said wafer, and
(e) repeating said steps (a) and (b) to said wafer when said step (d) has determined that said given burn-in stress has not been applied to said wafer.

17. The burn-in method according to claim 14, further comprising a step (d) of, after said step (c), applying repair to a part where a failure exists in said wafer.
